(19) United States
(12) Patent Application Publication
(10) Pub. No.: US 2021/0264782 A1
(43) Pub. Date: Aug. 26, 2021

(54) VEHICULAR EXTERNAL CONTROL COMMUNICATION SYSTEM

(71) Applicant: Zeyad Abbas, Lake Mary, FL (US)

(72) Inventor: Zeyad Abbas, Lake Mary, FL (US)

(21) Appl. No.: 16/801,141

(22) Filed: Feb. 25, 2020

(51) Int. Cl. G08G 1/0968; G08G 1/0967; B60W 60/00; G06F 16/27; G06F 21/44

(52) U.S. Cl. CPC G08G 1/0968; G08G 1/096725; B60W 2556/45; G06F 16/27; G06F 21/44; B60W 60/001

(57) ABSTRACT

The invention enables traffic controller to instruct autonomous vehicles in the event of emergencies or congestion. A vehicular external communication and control system includes a Traffic Control Module (TCM) based in a traffic control device such as a smart traffic light or and emergency services vehicle. The invention also includes a Traffic Control Electronic Control Unit (TCECU) installed in a vehicle that is communicatively linked to a TCM and to the vehicle computer bus. The TCM broadcasts to all TCECU-equipped vehicles within range. The TCECU-equipped vehicle provides status data to the traffic control device and the traffic control device issues instructions to the vehicle.

### CROSS-REFERENCE TO RELATED APPLICATIONS

This application claims the benefit of U.S. Application Ser. No. 62/810,889 filed on Feb. 26, 2019, the contents of which are incorporated herein by reference.

### TECHNICAL FIELD

The present invention relates generally to automated systems, and more particularly to a system for providing external communications and control of an automated or semi-automated vehicle.

### BACKGROUND

The statements in this section merely provide background information related to the present disclosure and may not constitute prior art.

Vehicle automation is the use of computer based control systems to augment or replace human input to operate a vehicle. The need for such systems is exemplified by our overburdened highway systems, where the differences in human reaction time cause sluggish traffic and deadly accidents each and every day.

In recent years, automobile manufacturers have begun incorporating many semi-autonomous features into their new vehicle offerings, such as brake assist, forward collision avoidance, lane departure warnings and adaptive cruise control, for example, with the goal of creating commercially viable automobiles that can operate in a sustained and fully automated capacity. Although this progress will undoubtedly lead to a safer transport system one day in the future, the advent of autonomous vehicles will undoubtedly lead to situations where there is an over-riding public interest in having an external authority, such as an emergency vehicle or a traffic routing system, to issue instructions to an autonomous vehicle in a standardized way.

Accordingly, it would be beneficial to provide a control mechanism that enables a duly constituted authority to transmit instructions, warnings and other information to an operating autonomous vehicle and for such an authority to receive relevant information about the status of a vehicles. It would also be beneficial if this communication mechanism conforms to an industry and/or government standard.

### SUMMARY OF THE INVENTION

The present invention is directed to a vehicular communication system that enables external traffic control systems and emergency services to acquire travel information and vehicle status data from vehicles, and to transmit instructions and information to those vehicles.

In one embodiment, this system enables emergency services such as fire, rescue, and police services to direct autonomous or semi-autonomous vehicles to make way.

In another embodiment, this system enables traffic routing devices to optimize the flow of traffic on the roadways by directing vehicles to specific routes and speeds.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a simplified block diagram of the vehicle external control communication system, in accordance with one embodiment of the invention.

FIG. 2 is a sequence diagram illustration the interactions between a traffic control system and a vehicle, as intermediated by a traffic control module connected via a radio frequency connection to a traffic control ECU installed on the vehicle, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, the term “active control mode” and derivatives thereof shall refer to the automation status/level of computer based control that is augmenting a human driver and/or assuming full control of a vehicle at any given time. In the preferred embodiment, an active control mode level can be defined by a standardized set of nomenclature which may be formed by the automobile industry and/or various government agencies so as to be universally recognized. One suitable nonlimiting example can include the 5-level automation nomenclature provided by the National Highway Traffic Safety Administration, as shown in Table 1.

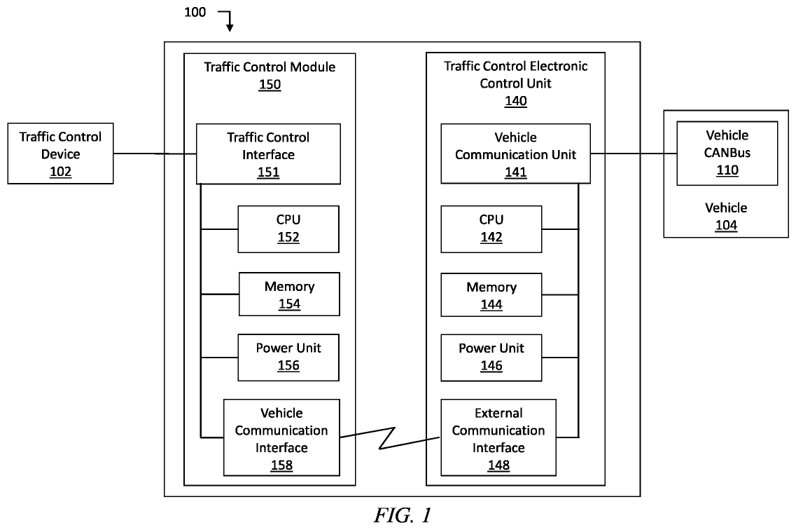

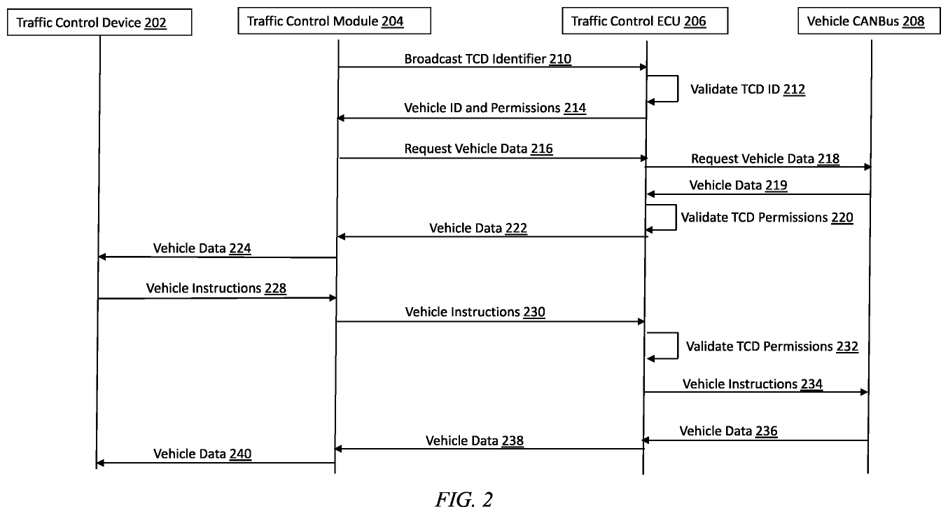

FIGS. 1-2 illustrate one embodiment of a vehicle external control communication system that are useful for understanding the inventive concepts disclosed herein. As will be described below, the system can be configured to allow for a variety of communication modes.

FIG. 1 is a simplified block diagram of the system 100 that includes a Traffic Control Electronic Control Unit (TCECU) 140, and a Traffic Control Module (TCM). As shown, the TCECU 140 can include, a main body having a processor 142 that is conventionally connected to a vehicle communication unit 141, an internal memory 144, a power unit 146, and an external communication interface unit 148. The TCM 150 can include, a main body having a processor 152 that is conventionally connected to a traffic control interface 151, an internal memory 154, a power unit 156, and an external communication interface unit 158. The TCM 150 and the TCECU 140 are connected in this embodiment by a radio frequency network, although alternative communication options can be utilized.

Although illustrated as separate elements, those of skill in the art will recognize that one or more system components may comprise, or include one or more printed circuit boards (PCB) containing any number of integrated circuit or circuits for completing the activities described herein. The CPU may be one or more integrated circuits having firmware for causing the circuitry to complete the activities described herein. Of course, any number of other analog and/or digital components capable of performing the below described functionality can be provided in place of, or in conjunction with the below described controller elements.

The main bodies of both the TCEDU 140 and the TCM 150 can include any number of different shapes and sizes, and can be constructed from any number of different materials suitable for encompassing each of the controller elements. In one preferred embodiment, the main body can be constructed from lightweight injection molded plastic having a plurality of internal connectors for securely housing each of the device elements. Of course, any number of other known construction materials such as PVC and composites, for example, are also contemplated. The main body of the TCECU 140 can be secured at any desirable location within or along the vehicle, and can preferably be positioned at or adjacent to the vehicle's automated control system. The main body of the TCM 150 can be secured at any desirable location within or adjacent to the connected Traffic Control System.

Within the TCECU 140, the CPU 142 can act to execute program code stored in the memory 144, in order to allow the device to perform the functionality described herein. Memory 144 can act to store operating instructions in the form of program code for the CPU 142 to execute. Although illustrated in FIG. 1 as a single component, memory 144 can include one or more physical memory devices such as, for example, local memory and/or one or more bulk storage devices. As used herein, local memory can refer to random access memory or other nonpersistent memory device(s) generally used during actual execution of program code, whereas a bulk storage device can be implemented as a persistent data storage device such as a hard drive, for example, containing programs that permit the CPU 142 to perform the traffic control communications and vehicle interactions described below. Additionally, memory 144 can also include one or more cache memories that provide temporary storage of at least some program code in order to reduce the number of times program code must be retrieved from the bulk storage device during execution. Each of these devices are well known in the art.

Within the TCECU 140, the vehicle communication unit 141 can include any number of components capable of communicating with a vehicle 104, either directly or over a network. In the preferred embodiment, the communication unit can include or comprise a Controller Area Network (CAN) Bus transceiver capable of providing two-way communication with the vehicle CAN 110. Moreover, other embodiments are contemplated wherein the vehicle communication unit includes functionality for communicating directly with other portions of the vehicle, such as the vehicles automated control system, that performs one or more automated functions within the vehicle.

Within the TCECU 140, the vehicle communication unit 141 can function to request and receive information from one or more of the other vehicle systems so as to allow the TCECU 140 to determine and/or recognize the current status and future intent of the vehicle. As will be described below, upon receiving such information, the TCECU 140 can selectively provide some or all of the vehicle status to the external traffic control device.

Within the TCECU 140, the vehicle communication unit 141 can function to issue instructions to other vehicle control systems in order to comply with requests and commands from duly authorized traffic control systems.

Within the TCECU 140, the power unit 146 can include any number of different components capable of providing the necessary power requirements to each element of the signaling system. To this end, the power unit can include or comprise any number of different batteries and/or can include an electrical power transformer and/or cord capable of allowing the signaling system to be powered by the vehicle's onboard electrical system.

Within the TCECU 140, the External Communications Interface unit 148 can function to provide a communicative link between the TCECU 140 and the TCM 150. In this regard, the External Communications Interface 148 can include any number of different elements such as one or more wireless transceivers, one or more PIC microcontrollers, one or more cellular network connections, and visual and audio signaling mechanisms. Of course, any other means for providing the two-way communication between the TCECU and the TCM are also contemplated. The External Communications Interface 148 is capable of multiple simultaneous connections to different TCM 150 systems across any of the available connection methods.

Within the TCM 150, the CPU 152 can act to execute program code stored in the memory 154, in order to allow the device to perform the functionality described herein. Memory 154 can act to store operating instructions in the form of program code for the CPU 152 to execute. Although illustrated in FIG. 1 as a single component, memory 154 can include one or more physical memory devices such as, for example, local memory and/or one or more bulk storage devices. As used herein, local memory can refer to random access memory or other nonpersistent memory device(s) generally used during actual execution of program code, whereas a bulk storage device can be implemented as a persistent data storage device such as a hard drive, for example, containing programs that permit the CPU 152 to perform the traffic control communications and vehicle interactions described below. Additionally, memory 154 can also include one or more cache memories that provide temporary storage of at least some program code in order to reduce the number of times program code must be retrieved from the bulk storage device during execution. Each of these devices are well known in the art.

Within the TCM 150, the power unit 156 can include any number of different components capable of providing the necessary power requirements to each element of the signaling system. To this end, the power unit can include or comprise any number of different batteries and/or can include an electrical power transformer and/or cord capable of allowing the signaling system to be powered by the vehicle's onboard electrical system.

Within the TCM 150, the Vehicle Communications Interface 158 can function to provide a communicative link between any number of TCECU 140 component installed on vehicles and the TCM 150. In this regard, the Vehicle Communications Interface 158 can include any number of different elements such as one or more wireless transceivers, one or more PIC microcontrollers, one or more cellular network connections, and visual and audio signaling mechanisms. Of course, any other means for providing the two-way communication between the TCECU and the TCM are also contemplated. The communications link is a one-to-many link between the TCM 150 and one or more vehicles across any of the available connection methods.

Within the TCM 150, the Traffic Control Interface (TCI) 151 can include any number of components capable of communicating with a Traffic Control Device (TCD) 102, either directly or over a network. In the preferred embodiment, the TCI 151 can incorporate a direct connection or a wired or wireless network connection to the TCD 102. Moreover, other embodiments are contemplated wherein the TCI 151 is connected over a long-haul communications network to a remote TCD 102. In addition, embodiments are contemplated wherein the TCD 102 is not a single system but a collection of systems connected via a network.

Within the TCM 150, the Traffic Control Interface (TCI) 151 can function to send and receive information between the TCEDU 140 systems installed on one or more vehicles and the TCD 102 system.

FIG. 2 is a simplified sequence diagram illustrating one embodiment of the communication between a TCM 204 and a TCECU 206.

In this embodiment, the TCM 204 sends periodic radio frequency broadcasts 210 advertising its presence and including identifying information. All TCECU 206 systems that receive this broadcast validate the identifying information 212. In this embodiment, each TCM 204 system has a set of permissions which determine what information the TCECU 206 provides to the TCM 204, and also determine what actions and instructions the TCECU 206 will respond to. The validation process conducted by the TCECU 206 uses the identifying information received from the TCM 204 to generate the permissions. The TCECU 206 responds to the TCM 204 with vehicle-unique identifying information, as well as the relevant permissions 214.

The TCM 204 can then request vehicle status data from the TCECU 206. In this embodiment the TCECU 206, in turn, requests this information either from its internal memory or by querying other vehicle systems across the CANBus 220. This information is processed 218 according to the permissions previously identified for the TCM 204, and validated vehicle status data is returned 222 to the TCM 204. This vehicle status data is then sent 224 by the TCM 204 to the TCD 202.

The TCD 202 can initiate an instruction for the vehicle to modify its behavior 228. These instructions are then transmitted 230 by the TCM 204 to the vehicle TCECU 206. If the instructions are in accordance with the previously identified permissions 232, the TCECU 206 sends appropriate messages to other vehicle systems to modify the vehicles' behavior 234.

In the preferred embodiment, the Vehicle Communication Interface 158 and the External Communication Interface 148 can include a variable radio wave transmitter having a unique radio frequency chip capable of transmitting a plurality of independent radio frequencies, which are stored in the memory (154 and/or 144). Of course, the transmitter is not limited to the use of a radio transmitter, as any number of other devices and/or transmission methodologies can also be utilized herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A distributed traffic information and control system comprising:
a traffic control module that interoperates with traffic control devices such as traffic lights, smart lanes, traffic routing systems, and/or emergency vehicles and which includes:
a traffic control interface unit that is communicatively linked to one or more traffic control devices,
a vehicle communication interface that communicates with one or more vehicles,
a processor for operation of the traffic control module, and
a memory that is encoded with instructions for instructing the processor to communicate with traffic control devices and with vehicles.
a vehicle control unit that includes:
a processor for operation of the vehicle control unit,
a memory that is encoded with instructions for instructing the processor to communicate with vehicles and with traffic control devices,
a vehicle communication unit that communicates with computer systems of the vehicle, receives vehicle operating information therefrom, and sends vehicle operating information thereto, and
an external communication unit that is communicatively linked to one or more traffic control modules.

2. The system of claim 1 where a vehicle modifies its speed, route, or other behavior in response to an instruction from a traffic control device.

3. The system of claim 1 where a traffic control device delivers general information to a plurality of vehicles within its operational control.

4. The system of claim 1 where a vehicle validate the credentials received from a traffic control device.

5. The system of claim 2 where a traffic control device coordinates the behaviors of one or more vehicles to optimize the flow of traffic through a specific area.

6. The system of claim 2 where a vehicle receives navigational instructions from a traffic control system.

7. The system of claim 4 where a vehicle validates the credentials of a traffic control device by referring to a local database.

8. The system of claim 4 where a vehicle validates the credentials of a traffic control device by referring to a remote database.

9. The system of claim 4 where a vehicle validates the credentials of a traffic control device by referring to a distributed-ledger system.

10. A method for controlling a plurality of vehicles from a traffic control device, comprising:
A vehicle communicating its operating information to a traffic control device,
A traffic control device receiving vehicle operating information,
A traffic control device issuing operating instructions to a vehicle, and
A vehicle modifying its operational state based on received instructions

11. The method of claim 10 wherein a traffic control device provides authentication information to a vehicle for the purpose of the vehicle enumerating permissions to be granted to said traffic control device, comprising:
A traffic control device sending authentication information to a vehicle
A vehicle validating authentication information sent from said traffic control device
A vehicle determining permissions and authorities of said traffic control device

12. Method of claim 11 wherein a vehicle communicating its operating information to a traffic control device is carried out in accordance with the permissions granted to the traffic control device according to its authentication information.

13. Method of claim 11 wherein a vehicle modifying its operational state is carried out in accordance with the permissions granted to the traffic control device according to its authentication information.
